(19) United States
(12) Patent Application Publication
(10) Pub. No.: US 2019/0136970 A1
(43) Pub. Date: May 9, 2019

(54) TRANSMISSION DEVICE

(71) Applicant: AISIN AW CO., LTD., Anjo-shi, Aichi-ken (JP)

(72) Inventors: Mitsuru TAKAHASHI, Hekinan (JP); Shinya TSUZUKI, Nishio (JP); Makoto IWANAKA, Okazaki (JP); Yuto YUASA, Nagoya (JP)

(73) Assignee: AISIN AW CO., LTD., Anjo-shi, Aichi-ken (JP)

(21) Appl. No.: 15/779,698

(22) PCT Filed: Dec. 21, 2016
(86) PCT No.: PCT/JP2016/088072

§ 371 Date: May 29, 2018

(30) Foreign Application Priority Data
Jan. 28, 2016 (JP) 2016-014274

(51) Int. Cl. F16H 61/06; F16H 61/00

(52) U.S. Cl. CPC F16H 61/061; F16H 61/0021; F16H 2059/746; F16H 2061/062; F16H 2312/14; F16H 2061/0034

(57) ABSTRACT

A transmission device is provided with a hydraulic control device, which has a pump for generating hydraulic pressure using power from a motor, and an accumulator, and which controls hydraulic pressure and supplies the hydraulic pressure to a hydraulic servo of an engagement element. The transmission device executes, when the motor that automatically stopped starts up with a request for vehicle travel: a fill control in which the hydraulic control device is controlled so that the hydraulic servo is being filled with working oil; a standby control to control the hydraulic pressure in the hydraulic servo at a standby pressure; and an engagement control to increase the hydraulic pressure in the hydraulic servo is started when the rotational speed of the motor becomes reaches or exceeds a prescribed rotational speed, after hydraulic pressure accumulated in the accumulator is released into the hydraulic circuit, so that the engagement element is engaged.

### CROSS REFERENCE TO RELATED APPLICATIONS

This application is a National Stage of International Application No. PCT/JP2016/088072 filed Dec. 21, 2016, claiming priority based on Japanese Patent Application No. 2016-014274 filed Jan. 28, 2016.

### TECHNICAL FIELD

The aspects of the application relate to a transmission device.

### BACKGROUND ART

There has hitherto been known a transmission device of this type provided with a hydraulic control device which includes: an oil pump that is operated using power from an engine; a forward clutch connected to the oil pump via an oil passage; an accumulator provided in a branch oil passage that branches from the oil passage; and a switching valve capable of disconnecting the accumulator and the oil passage. The hydraulic control device closes the switching valve when the engine stops in order to maintain hydraulic pressure accumulated in the accumulator during engine operation, and opens the switching valve when the engine restarts in order to supply hydraulic pressure accumulated in the accumulator to the forward clutch (for example, see Patent Document 1).

### RELATED ART DOCUMENT

### Patent Document

Patent Document 1: Japanese Patent Application Publication No. 2000-313252 (JP 2000-313252 A)

### SUMMARY

However, in the transmission device described above, the hydraulic pressure supplied to the forward clutch when the engine is restarted is dependent on the hydraulic pressure accumulated in the accumulator and the discharge hydraulic pressure of the oil pump that is driven when the engine restarts. When the rotational speed of the oil pump is low immediately after the engine is restarted, the discharge hydraulic pressure of the oil pump is unstable, although accumulated hydraulic pressure is supplied from the accumulator. Therefore, the hydraulic pressure supplied to the forward clutch varies and transmission torque of the forward clutch varies accordingly, which may give a sense of discomfort to a driver.

It is an aspect of a transmission device of the disclosure to engage an engagement element more appropriately when a motor that stopped automatically starts up.

The means described below are intended to achieve the aspects described above.

A transmission device of the disclosure which is mounted on a vehicle including a motor configured to automatically stop and automatically start, that shifts and transmits power from the motor to an axle via an engagement element, including: a hydraulic control device which has a pump that discharges working oil into a hydraulic circuit using power from the motor, and an accumulator that accumulates hydraulic pressure in the hydraulic circuit, and which controls the hydraulic pressure in the hydraulic circuit and supplies the hydraulic pressure to a hydraulic servo of the engagement element; and a start control device that executes, when the motor that automatically stopped starts up with a request for vehicle travel: a fill control in which the hydraulic control device is controlled so that the hydraulic servo is being filled with working oil; a standby control in which the hydraulic control device is controlled so that hydraulic pressure in the hydraulic servo is maintained at a standby pressure; and an engagement control in which the hydraulic control device is controlled so that the increase of hydraulic pressure in the hydraulic servo is started when the rotational speed of the motor becomes equal to or more than a prescribed rotational speed in this order, after hydraulic pressure accumulated in the accumulator is released into the hydraulic circuit, so that the engagement element is engaged.

In the transmission device according to the disclosure, the transmission device executes, when the motor that automatically stopped starts up with a request for vehicle travel: a fill control in which the hydraulic control device is controlled so that the hydraulic servo is being filled with working oil; a standby control in which the hydraulic control device is controlled so that hydraulic pressure in the hydraulic servo is maintained at a standby pressure; and an engagement control in which the hydraulic control device is controlled so that the increase of hydraulic pressure in the hydraulic servo is started when the rotational speed of the motor becomes equal to or more than a prescribed rotational speed in this order, after the hydraulic pressure accumulated in the accumulator is released into the hydraulic circuit, so that the engagement element is engaged. When the rotational speed of the motor is low, the rotational speed of the pump is low, and a discharge pressure varies greatly. Therefore, by starting to increase the hydraulic servo after the rotational speed of the motor exceeds a threshold, it is possible to execute the engagement control in a state where the variation of the discharge pressure of the pump is stable, and suppress engagement shock of the engagement element.

### BRIEF DESCRIPTION OF THE DRAWINGS

FIG. 1 is a schematic diagram of the overall structure of a vehicle 10 mounted with a transmission device 20 according to an embodiment of the disclosure.

FIG. 2 is a schematic diagram of the overall mechanical structure of the transmission device 20 that includes an automatic transmission 25.

FIG. 3 is an explanatory diagram that shows an operation table representing relations of each shift speed of the automatic transmission 25 with each of the operating states of clutches C1 to C4, brakes B1 and B2, and a one-way clutch F1.

FIG. 4 is a schematic diagram of the structure of a hydraulic control device 60.

FIG. 5 is a flowchart of an example of a start-off control routine executed by a transmission ECU 80.

FIG. 6 is a flowchart of an example of a standby control routine executed by the transmission ECU 80.

FIG. 7 is an explanatory diagram of an example of a map for setting a required standby pressure.

FIG. 8 is an explanatory diagram showing the engine rotational speed Ne, the hydraulic pressure command P* of the clutch C1, and accumulator discharge signals varying over time, when an engine 12 is started to start the vehicle 10.

FIG. 9 is a flowchart of the start-off control routine of another embodiment.

### PREFERRED EMBODIMENTS

Next, an embodiment of the present application will be described below with reference to the drawings.

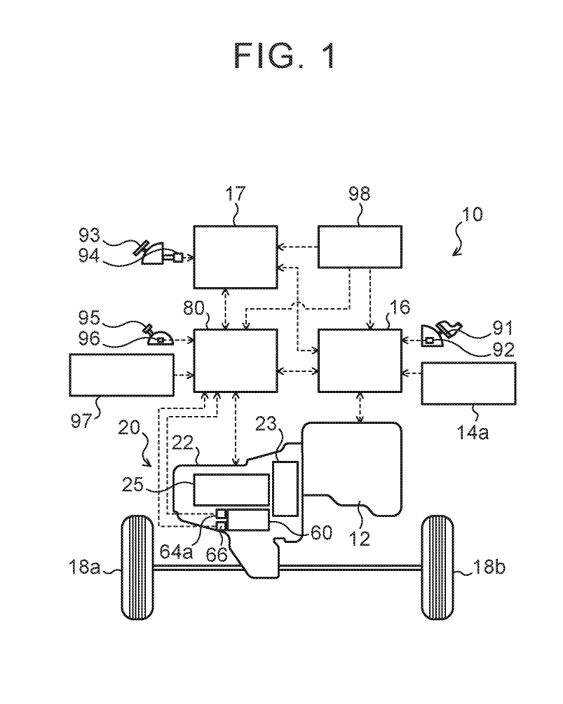

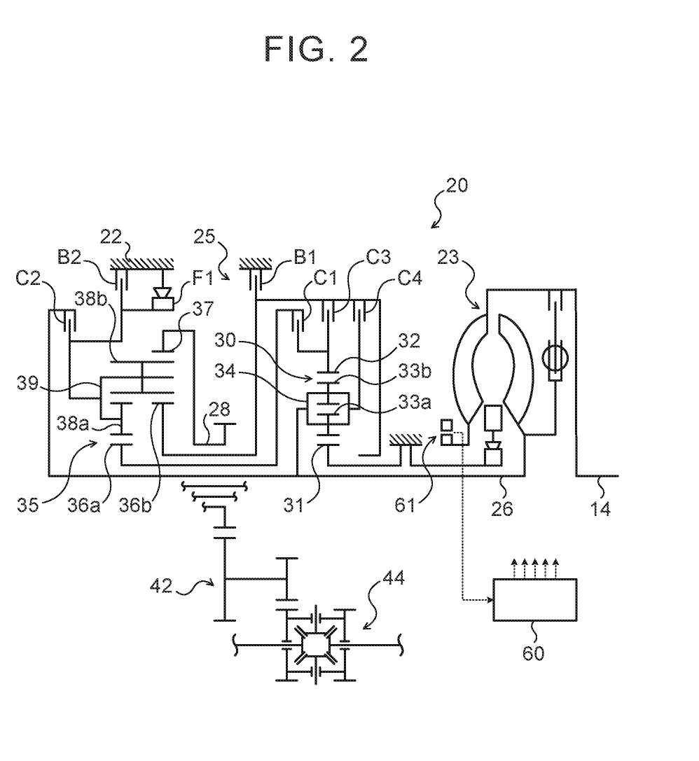

FIG. 1 is a schematic diagram of the structure of a vehicle 10 mounted with a transmission device 20 according to an exemplary embodiment of the disclosure. FIG. 2 is a schematic diagram of the mechanical structure of the transmission device 20 that includes an automatic transmission 25.

As shown in FIG. 1 and FIG. 2, the vehicle 10 includes: an engine 12; an engine electronic control unit (hereinafter referred to as an engine ECU) 16 that controls the operation of the engine 12; a hydraulic transmission device 23 mounted on a crankshaft 14 of the engine 12; the stepped automatic transmission 25 in which an input shaft 26 is connected to an output side of the hydraulic transmission device 23 and an output shaft 28 is connected to driving wheels 18a, 18b via a gear mechanism 42 and a differential gear 44, and power input from the input shaft 26 is shifted and transmitted to the output shaft 28; a hydraulic control device 60 that supplies working oil to the hydraulic transmission device 23 and the automatic transmission 25; a transmission electronic control unit (hereinafter referred to as a transmission ECU) 80 that controls the hydraulic transmission device 23 and the automatic transmission 25 by controlling the hydraulic control device 60; and a brake electronic control unit (hereinafter referred to as a brake ECU) 17 that controls an electronically-controlled hydraulic brake unit that is not shown. Here, mainly the automatic transmission 25, the hydraulic control device 60, and the transmission ECU 80 correspond to the transmission device 20.

The engine ECU 16 is configured as a microprocessor that includes a CPU as a main component, and includes, other than the CPU, a ROM that stores a processing program, a RAM that temporarily stores data, an input/output port, and a communication port. The engine ECU 16 receives, via input ports, signals from various sensors that detect the operation state of the engine 12, such as a signal indicating an engine rotational speed Ne from a rotational speed sensor 14a that is mounted on the crankshaft 14. The engine ECU 16 also receives, via input ports, signals such as the accelerator operation amount Acc from an accelerator pedal position sensor 92 that detects the accelerator operation amount Acc as the stepping amount of an accelerator pedal 91 and a vehicle speed V from a vehicle speed sensor 98. Signals such as a drive signal for a throttle motor that drives the throttle valve, a control signal for a fuel injection valve, and an ignition signal for a spark plug are output from the engine ECU 16 via the output port.

As shown in FIG. 2, the hydraulic transmission device 23 is structured as a hydraulic torque converter with a lockup clutch that has a pump impeller, a turbine runner, a stator, a one-way clutch, and a lockup clutch etc.

The automatic transmission 25 is structured as an eight-speed transmission. As shown in FIG. 2, the automatic transmission 25 includes a double pinion-type first planetary gear mechanism 30, a Ravigneaux-type second planetary gear mechanism 35, four clutches C1, C2, C3 and C4 and two brakes B1 and B2 for changing a power transmission path from the input side to the output side, and a one-way clutch F1.

The first planetary gear mechanism 30 of the automatic transmission 25 includes a sun gear 31 that is an external gear, a ring gear 32 that is an internal gear arranged concentrically with the sun gear 31, and a planetary carrier 34 that rotatably (turnably) and revolvably holds a plurality of sets of two pinion gears 33a, 33b that mesh with each other while one meshes with the sun gear 31 and the other meshes with the ring gear 32. As shown in the figure, the sun gear 31 of the first planetary gear mechanism 30 is fixed to a transmission case 22, and the planetary carrier 34 of the first planetary gear mechanism 30 is coupled so as to be rotatable together with the input shaft 26. The first planetary gear mechanism 30 is structured as a so-called speed reduction gear, and decelerates the power transferred to the planetary carrier 34 which serves as an input element to output the power from the ring gear 32 which serves as an output element.

The second planetary gear mechanism 35 of the automatic transmission 25 has a first sun gear 36a and a second sun gear 36b as external gears, a ring gear 37 as an internal gear placed concentrically with the first and second sun gears 36a, 36b, a plurality of short pinion gears 38a meshing with the first sun gear 36a, a plurality of long pinion gears 38b meshing with the second sun gear 36b and the short pinion gears 38a as well as the ring gear 37, and a planetary carrier 39 that rotatably (turnably) and revolvably holds the short pinion gears 38a and the long pinion gears 38b. The ring gear 37 of the second planetary gear mechanism 35 functions as an output member of the automatic transmission 25. The power transmitted from the input shaft 26 to the ring gear 37 is transmitted to the left and right driving wheels 18a, 18b via the gear mechanism 42 and the differential gear 44. The planetary carrier 39 is supported by the transmission case 22 via the one-way clutch F1, and the one-way clutch F1 permits the planetary carrier 39 to rotate only in one direction.

The clutches C1 to C4 are each structured as a multi-plate friction hydraulic clutch that has a piston, a clutch plate formed by a plurality of friction plates and separator plates, and a hydraulic servo structured by an oil chamber to which working oil is supplied etc., and that can connect and disconnect two rotation systems. The clutch C1 can connect the ring gear 32 of the first planetary gear mechanism 30 and the first sun gear 36a of the second planetary gear mechanism 35 to each other, and disconnect the ring gear 32 and the first sun gear 36a from each other. The clutch C2 can connect the input shaft 26 and the planetary carrier 39 of the second planetary gear mechanism 35 to each other, and disconnect the input shaft 26 and the planetary carrier 39 from each other. The clutch C3 can connect the ring gear 32 of the first planetary gear mechanism 30 and the second sun gear 36b of the second planetary gear mechanism 35 to each other, and disconnect the ring gear 32 and the second sun gear 36b from each other. The clutch C4 can connect the planetary carrier 34 of the first planetary gear mechanism 30 and the second sun gear 36b of the second planetary gear mechanism 35 to each other, and disconnect the planetary carrier 34 and the second sun gear 36b from each other.

The brakes B1, B2 are both structured as a multi-plate friction hydraulic brake that has friction plates and separator plates, and a hydraulic servo structured by an oil chamber to which working oil is supplied etc., and that can connect and disconnect a rotation system to a fixed system. The brake B1 can make the second sun gear 36b of the second planetary gear mechanism 35 stationary with respect to the transmission case 22, and make the second sun gear 36b non-stationary with respect to the transmission case 22. The brake B2 can make the planetary carrier 39 of the second planetary gear mechanism 35 stationary with respect to the transmission case 22, and make the planetary carrier 39 non-stationary with respect to the transmission case 22.

The one-way clutch F1 has an inner race coupled (fixed) to the planetary carrier 39 of the second planetary gear mechanism 35, an outer race fixed to the transmission case 22, and a torque transmitting member (a plurality of sprags etc.) disposed between the inner race and the outer race, and permits the planetary carrier 39 to rotate in only one direction.

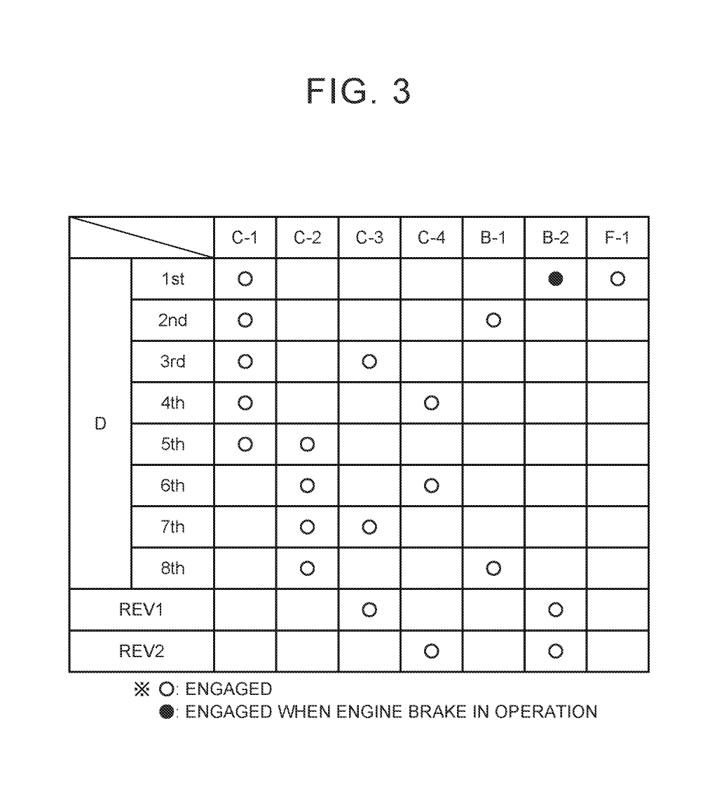

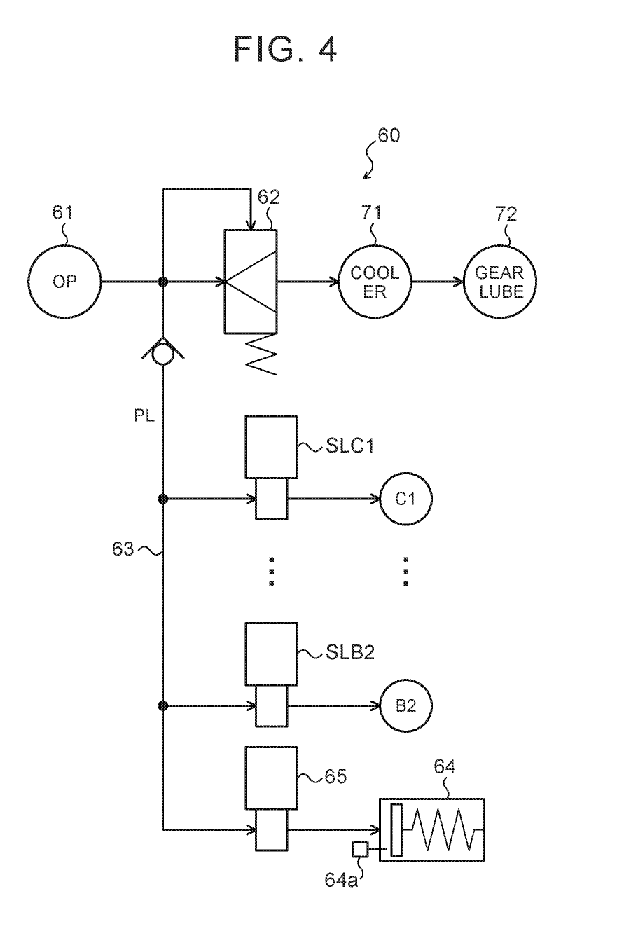

The clutches C1 to C4 and the brakes B1 and B2 operate with working oil supplied thereto and discharged therefrom by the hydraulic control device 60 described above. FIG. 3 shows an operation table representing relations of each shift speed of the automatic transmission 25 with each of the operating states of the clutches C1 to C4, the brakes B1 and B2, and the one-way clutch F1. The automatic transmission 25 places the clutches C1 to C4 and the brakes B1 and B2 in the states shown in the operation table of FIG. 3 so as to provide first to eighth forward shift speeds and first and second reverse shift speeds. Specifically, as shown in FIG. 3, the first forward speed is formed by engaging the clutch C1. When the engine brake is applied, the brake B2 is also engaged for the first forward speed. The second forward speed is formed by engaging the clutch C1 and the brake B1. The third forward speed is formed by engaging the clutch C1 and the clutch C3. The fourth forward speed is formed by engaging the clutch C1 and the clutch C4. The fifth forward speed is formed by engaging the clutch C1 and the clutch C2. The sixth forward speed is formed by engaging the clutch C2 and the clutch C4. The seventh forward speed is formed by engaging the clutch C2 and the clutch C3. The eighth forward speed is formed by engaging the clutch C2 and the brake B1. The first reverse speed is formed by engaging the clutch C3 and the brake B2. The second reverse speed is formed by engaging the clutch C4 and the brake B2.

The hydraulic control device 60 includes: an oil pump 61 that feeds working oil with pressure by the power of the engine 12; a regulator valve 62 that supplies a part of the working oil fed by the oil pump 61 with pressure to a cooler 71 and an object 72 to be lubricated such as a gear or a bearing while regulating the pressure of working oil, and generates line pressure PL in a line pressure oil passage 63; linear solenoid valves SLC1 to SLC4, SLB1, and SLB2 (SLC2 to SLC4 not shown) each regulates line pressure PL of the line pressure oil passage 63 and supplies it to each of the hydraulic servos of the clutches C1 to C4 and the brakes B1, B2; an accumulator 64 that is an accumulator for accumulating hydraulic pressure from the oil pump 61; and an on/off solenoid valve 65 that allows/blocks communication between the accumulator 64 and the line pressure oil passage 63.

The transmission ECU 80 is configured as a microprocessor that includes a CPU as a main component, and includes, other than the CPU, a ROM that stores a processing program, a RAM that temporarily stores data, an input/output port, and a communication port. The transmission ECU 80 receives, via input ports, inputs such as an accumulator internal pressure Pacc from a pressure sensor 64a that detects the pressure inside the accumulator 64, an oil temperature Toil from an oil temperature sensor 66 that detects the oil temperature of the working oil inside the hydraulic control device 60, a shift position SP from a shift position sensor 96 that detects the position of a shift lever 95, a switching signal (driving mode) from a driving mode switch 97 that selects any of a plurality of driving modes which include a normal mode, an eco-mode that prioritizes fuel consumption, and a power mode that prioritizes output of power, and the vehicle speed V from the vehicle speed sensor 98. In the embodiment, a parking position (P position) for parking, a reverse position (R position) for reverse traveling, a neutral position (N position) that is neutral, and a normal driving position (D position) for forward traveling, are provided as the shift positions SP of the shift lever 95. Control signals for the hydraulic control device 60 (linear solenoid valves SLC1, SLB2, on/off solenoid valve 65) and the like are output from the transmission ECU 80 via the output port.

The engine ECU 16, the brake ECU 17, and the transmission ECU 80 are connected with one another through communication ports, and exchange with each other various control signals and data that are necessary for control. The transmission ECU 80 receives inputs such as the accelerator operation amount Acc from the accelerator pedal position sensor 92 via the engine ECU 16 through communication and a brake operation amount B from a brake pedal position sensor 94 that detects the stepping amount of a brake pedal 93 via the brake ECU 17 through communication.

In the vehicle 10 structured in this way, the engine ECU 16 executes idling stop control. The idling stop control stops fuel supply to the engine 12 so that the engine 12 automatically stops when the automatic stopping conditions for the engine 12 are satisfied, those conditions being the vehicle speed V is below a prescribed vehicle speed and the accelerator is off etc. The idling stop control also cranks the engine 12 so that the engine 12 automatically starts when the automatic starting conditions of the engine 12 are satisfied, those conditions being the engine 12 is automatically stopped, the brake is off, and the accelerator is on etc.

When the engine 12 is operating, the transmission ECU 80 opens the on/off solenoid valve 65 and accumulates the hydraulic pressure from the oil pump 61 that is operated by the power from the engine 12. When the engine 12 automatically stops, the transmission ECU 80 closes the on/off solenoid valve 65 and holds the hydraulic pressure accumulated in the accumulator 64. When the engine 12 is automatically started again, the transmission ECU 80 opens the on/off solenoid valve 65 and releases the hydraulic pressure (accumulator internal pressure Pacc) accumulated in the accumulator 64 to the line pressure oil passage 63. Then, the transmission ECU 80 prepares for engagement of the clutch C1 that forms the first forward speed using the accumulator internal pressure Pacc, until the engine 12 starts and the oil pump 61 operates.

The transmission ECU 80 detects the hydraulic pressure (accumulator internal pressure Pacc) accumulated in the accumulator 64 when the engine 12 is operating. Then, after the detected hydraulic pressure becomes equal to or more than the threshold, the transmission ECU 80 sends to the engine ECU 16 an automatic stopping permission signal that permits the engine 12 to automatically stop. The engine ECU 16 does not trigger the automatic stop of the engine 12 until it receives the automatic stopping permission signal, even if the automatic stopping conditions for the engine 12 are satisfied. Thus, the accumulator internal pressure (stopping permission threshold) that permits the engine 12 to automatically stop is set with in mind the leakage quantity of the working oil during automatic stop of the engine 12 so that the hydraulic pressure necessary for engagement preparation of the clutch C1 when the engine 12 is started to start the vehicle 10 again can be provided by the hydraulic pressure accumulated in the accumulator 64, after the engine 12 is automatically stopped. Then, the automatic stopping permission signal is sent to the engine ECU 16 when the accumulator internal pressure Pacc from the pressure sensor 64a becomes equal to or more than the stopping permission threshold. The stopping permission threshold can be changed appropriately according to the state of the vehicle. For example, it can be changed according to the driving mode (normal mode, eco-mode, or power mode). Specifically, the stopping permission threshold can be a smaller value compared to the normal mode when the driving mode is the eco-mode, and the stopping permission threshold can be a larger value compared to the normal mode when the driving mode is the power mode.

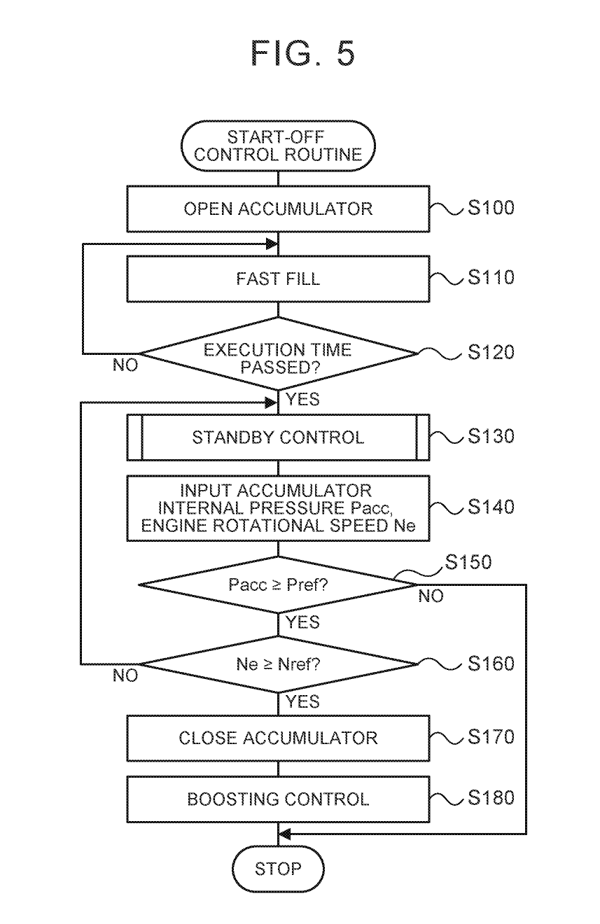

Next, the operation of the transmission device 20 according to the embodiment thus structured will be described, especially the operation of the transmission device 20 when the engine 12 is started to start the vehicle 10. FIG. 5 is a flowchart of an example of a start-off control routine. This routine is executed by the transmission ECU 80 when the automatic starting conditions of the engine 12 are satisfied.

When the start-off control routine is executed, the CPU of the transmission ECU 80 first opens the on/off solenoid valve 65 so that hydraulic pressure accumulated in the accumulator 64 is released to the line pressure oil passage 63 (step S100). Next, a fast fill control (fill control) is executed (step S110). Here, the fast fill control is a control that uses the hydraulic pressure accumulated in the accumulator 64 to quickly charge working oil in the hydraulic servo of the clutch C1 so that the clutch C1 that forms the first forward speed is in a state right before engagement (a state where a clutch piston of the clutch C1 reaches its stroke end, and there is generally no clearance between the clutch piston and the clutch plate). The fast fill control is executed by controlling driving of the linear solenoid valve SLC1 that corresponds to the clutch C1 at a relatively high duty ratio. The fast fill control is executed until a predetermined execution time has elapsed since the start of the fast fill control.

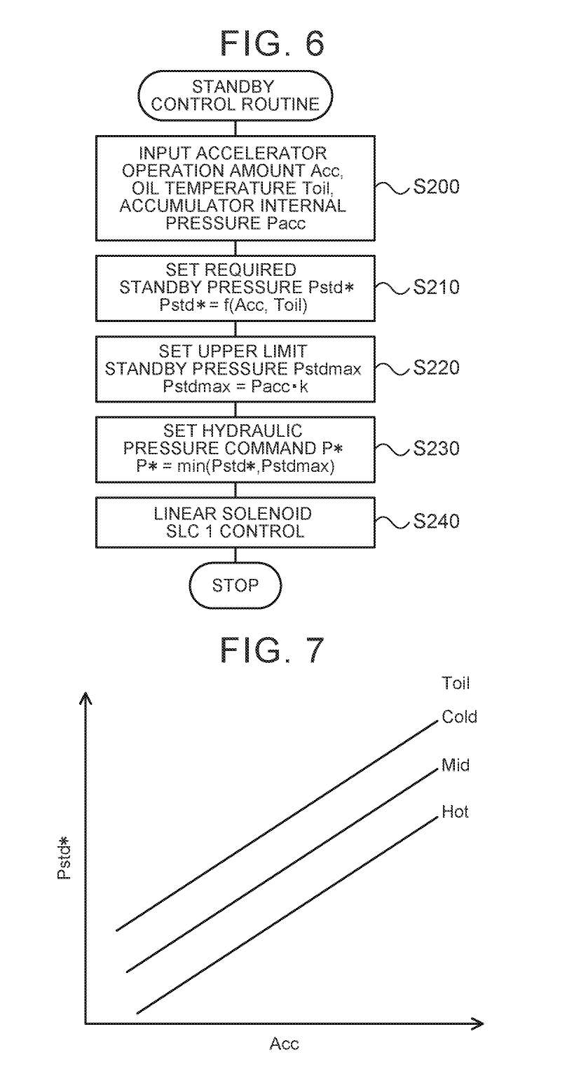

When the execution time elapses since the start of the fast fill control (step S120), standby control is executed (step S130). Here, the standby control is a control that holds the hydraulic pressure for the hydraulic pressure servo of the clutch C1 at a relatively low standby pressure, and is carried out by executing the standby control routine in FIG. 6. The standby pressure is a hydraulic pressure that moves the clutch piston of the clutch C1 to its stroke end, and is a hydraulic pressure that is increased up to and maintained at a prescribed hydraulic pressure level to engage the clutch. The standby pressure is also a hydraulic pressure for holding a state in which the torque capacity is at least smaller than the engine torque after perfect ignition of the engine (a state in which the engine can maintain rotation by itself). Preferably, the standby pressure is a hydraulic pressure for holding the clutch C1 in a state right before the torque capacity is generated (right before engagement starts). In the standby control routine, the transmission ECU 80 receives inputs of the accelerator operation amount Acc, the oil temperature Toil, the accumulator internal pressure Pacc, and the driving mode (normal mode, eco-mode, or power mode) (step S200). Then, the transmission ECU 80 sets a required standby pressure Pstd* based on the input accelerator operation amount Acc, the oil temperature Toil, and the driving mode (step S210). Here, the setting of the required standby pressure Pstd* is carried out by determining the relationship of the accelerator operation amount Acc, the oil temperature Toil, and the required standby pressure Pstd* beforehand and storing it in the ROM as a map, and then, when the accelerator operation amount Acc and the oil temperature Toil provided, deriving the corresponding required standby pressure Pstd* from the map. An example of the map for setting the required standby pressure is shown in FIG. 7. As shown in FIG. 7, the required standby pressure Pstd* is set to a value that increases as the accelerator operation amount Acc increases, such that the larger the accelerator operation amount, the higher the response of the clutch engagement will be. Additionally, the required standby pressure Pstd* is set to a value that increases as the oil temperature Toil decreases, since the lower the oil temperature Toil, the higher the viscosity of the working oil is. In the embodiment, different maps are prepared for each driving mode as the map for setting the required standby pressure. In the eco-mode map, a smaller value is set as the required standby pressure Pstd* with respect to the same accelerator operation amount Acc and the oil temperature Toil, compared to the normal mode map. In the power mode map, a larger value is set as the required standby pressure Pstd* with respect to the same accelerator operation amount Acc and the oil temperature Toil, compared to the normal mode map. Next, an upper limit standby pressure Pstdmax is set based on the input accumulator internal pressure Pacc (step S220). Then, the smaller one of the set upper limit standby pressure Pstdmax and the required standby pressure Pstd* is set as a hydraulic pressure command P* (step S230). Then, the driving of the linear solenoid valve SLC1 is controlled based on the set hydraulic pressure command P* (step S240), and the standby control routine is terminated.

After the standby control is executed, in the start-off control routine again, the accumulator internal pressure Pacc and the engine rotational speed Ne are input (step S140). Then, whether the input accumulator internal pressure Pacc is equal to or more than a threshold Pref is determined (step S150), and whether the input engine rotational speed Ne is equal to or more than a threshold Nref is determined (step S160). Here, the threshold Pref is set as the minimum value of the accumulator internal pressure necessary for the execution of the standby control described above. Additionally, the threshold Nref is set as the minimum value of the engine rotational speed necessary for the operation of the oil pump 61. If it is determined that the accumulator internal pressure Pacc is equal to or more than the threshold Pref, but the engine rotational speed Ne is not equal to or more than the threshold Ne, the routine returns to step S130 and standby control is continuously executed. If it is determined that the accumulator internal pressure Pacc is equal to or more than the threshold Pref, and the engine rotational speed Ne is equal to or more than the threshold Nref, the on/off solenoid valve 65 is closed so that the accumulator 64 is disconnected from the line pressure oil passage 63 (step S170), pressuring control is executed (step S180), and the start-off control routine is terminated. Here, the pressuring control is executed by controlling driving of the linear solenoid valve SLC1 so that hydraulic pressure to the hydraulic servo of the clutch C1 gradually increases in order to completely engage the clutch C1 using the hydraulic pressure from the oil pump 61.

If the accumulator internal pressure Pacc becomes less than the threshold Pref before the engine rotational speed Ne is determined to be equal to or more than the threshold Nref in step S160, it is determined that the execution of the standby control using the accumulator internal pressure Pacc cannot be maintained, the standby control is discontinued, and the start-off control routine is terminated. In this case, the fast fill control, the standby control, and the pressuring control described above are successively executed using the hydraulic pressure from the oil pump 61, after the engine rotational speed Ne becomes equal to or more than the threshold Nref, that is, after the oil pump 61 starts operating.

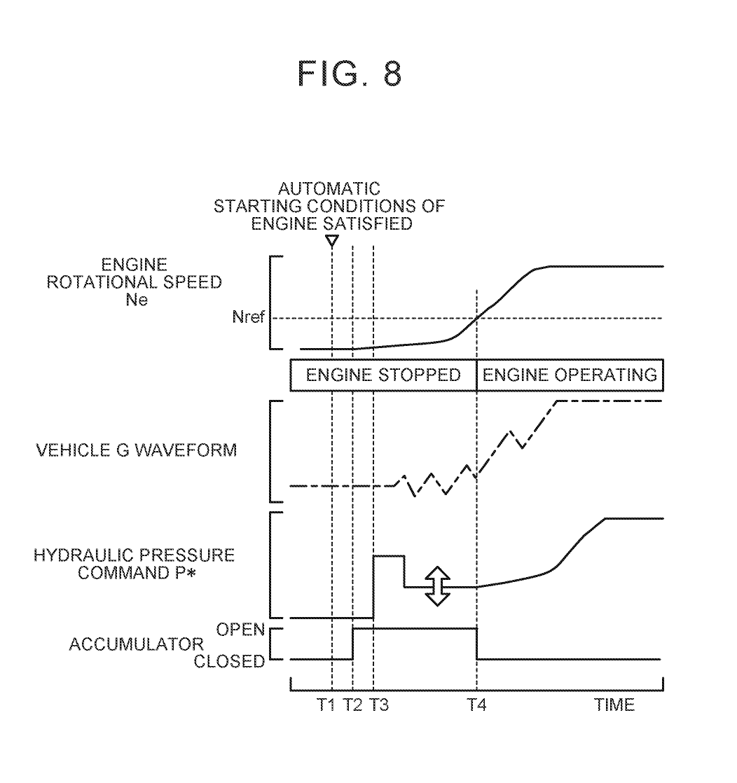

FIG. 8 is an explanatory diagram showing the engine rotational speed Ne, the hydraulic pressure command P* of the clutch C1, and the opening and closing of the accumulator varying over time, when the engine 12 is started to start the vehicle 10. As shown in FIG. 8, the starting conditions are satisfied and cranking of the engine 12 is started at time T1. Then, at time T2, the accumulator 64 is opened and the accumulated hydraulic pressure is released into the line pressure oil passage 63 by opening the on/off solenoid valve 65. Then at time T3, fast fill control is executed for the hydraulic servo of the clutch C1 that forms the first forward speed, and the standby control is executed. For the standby control, the hydraulic pressure command P* is set based on the accelerator operation amount Acc, the oil temperature Toil, and the driving mode. Thus, regarding the relatively low accelerator operation amount Acc, it is possible to prevent a shock caused by the starting (cranking) of the engine 12 from being transmitted to the driving wheels 18a, 18b via the clutch C1. Regarding the relatively high accelerator operation amount Acc, it is possible to improve the response of the clutch engagement as well as prevent racing of the engine 12. At this time, the setting of the hydraulic pressure command P* for standby control is carried out with the upper limit standby pressure Pstdmax, which is based on the accumulator internal pressure Pacc, as the limit. Therefore, the controllability of the standby control that uses the accumulator 64 and the pressuring control afterwards can be made satisfactory. At time T4, the engine rotational speed Ne becomes equal to or more than the threshold Nref, the oil pump 61 starts to operate, and the hydraulic pressure to the hydraulic servo of the clutch C1 is increased using the hydraulic pressure from the oil pump 61 in the place of the hydraulic pressure from the accumulator 64, so that the clutch C1 is completely engaged.

In the transmission device 20 of the disclosure described above, in which when the engine 12 that automatically stopped starts up, the standby pressure (hydraulic pressure command P*) in the standby control can be changed by executing the fast fill control that quickly fills the hydraulic servo of the starting clutch C1 with the working oil, the standby control that makes the hydraulic pressure for the hydraulic servo standby with the standby pressure, and the pressuring control that increases the hydraulic pressure for the hydraulic servo. Thus, by increasing the standby pressure, the response to the engagement of the clutch C1 can be improved. By decreasing the standby pressure, it is possible to suppress engagement shock that occurs when the clutch C1 is engaged. As a result, the engagement of an engagement element when a motor that automatically stopped starts can be performed more appropriately.

In the transmission device 20 of the disclosure, the standby pressure in the standby control is changed based on the accelerator operation amount Acc. Therefore, regarding the relatively small accelerator operation amount Acc, it is possible the prevent the shock caused by the starting (cranking) of the engine 12 from being transmitted to the driving wheels 18a, 18b via the clutch C1. Regarding the relatively large accelerator operation amount Acc, it is possible to improve the response of the clutch engagement and avoid racing of the engine 12.

Additionally, in the transmission device 20 of the disclosure, the standby pressure (hydraulic pressure command P*) can be changed with the upper limit standby pressure Pstdmax as its limit, the upper limit standby pressure Pstdmax being based on the accumulator internal pressure Pacc. Therefore, the controllability of the standby control that uses the accumulator internal pressure Pacc and the pressuring control afterwards can be made satisfactory.

In the transmission device 20 of the disclosure, the standby control is discontinued when the accumulator internal pressure Pacc becomes lower than the threshold Pref, before the engine rotational speed Ne becomes equal to or more than the threshold Nref, at which the operation of the oil pump 61 is started, during execution of the standby control. Therefore, it is possible to promptly respond to an improper engagement of the clutch C1.

In the transmission device 20 of the disclosure, the required standby pressure Pstd* is set in the standby control, based on the accelerator operation amount Acc, the oil temperature Toil, and the driving mode. However, the required standby pressure Pstd* may be set based on any one or two of the three parameters. The required standby pressure Pstd* may also be set considering other parameters.

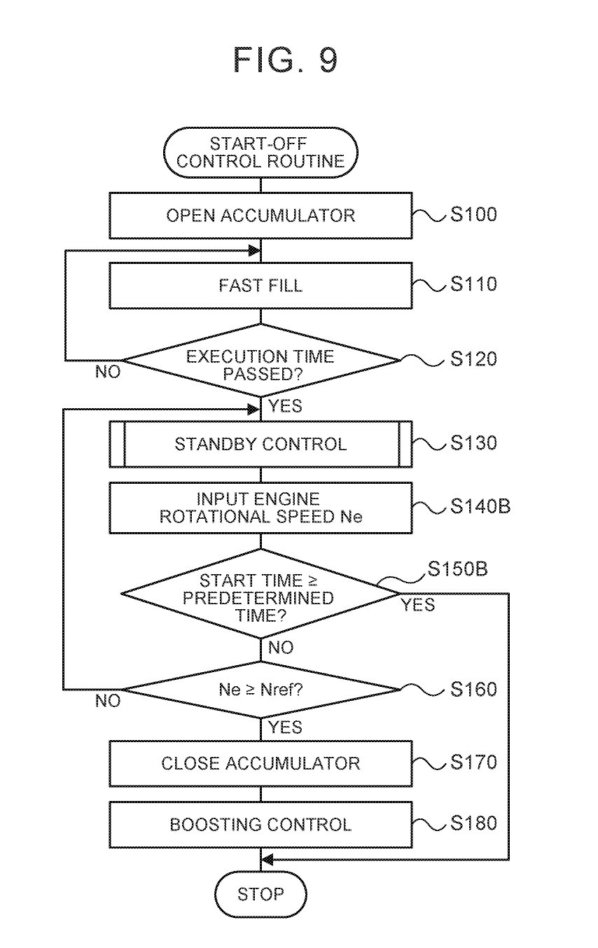

In the transmission device 20 of the disclosure, the standby control is discontinued when the accumulator internal pressure Pacc becomes lower than the threshold Pref before the engine rotational speed Ne becomes equal to or more than the threshold Nref, at which the operation of the oil pump 61 is started, during execution of the standby control. However, as shown in the start-off control routine of another embodiment in FIG. 9, the standby control may be discontinued when the engine rotational speed Ne does not become equal to or more than the threshold Nref until the prescribed time passes since the start-up of the engine 12 is initiated (steps S140B, 5150B).

In the transmission device 20 of the disclosure, the accumulator internal pressure Pacc is detected by the pressure sensor 64a. However, the accumulator internal pressure Pacc may be estimated without the pressure sensor 64a. The estimation of the accumulator internal pressure Pacc can be performed for each of the following states of the accumulator 64: a filling state in which the accumulator 64 is being filled with working oil; a holding state in which working oil is held in the accumulator 64; and a discharging state in which working oil is discharged from the accumulator 64. For example, when the accumulator 64 is in the filling state, the variation per unit time of the hydraulic pressure (filling rate) while the accumulator 64 is being filled with working oil is determined based on the oil temperature (the variation per unit time becomes smaller as the oil temperature decreases, since the lower the oil temperature, the lower the viscosity of the working oil is). Then, the increasing hydraulic pressure is time-integrated by the determined filling rate. Thus, the accumulator internal pressure Pacc can be estimated. Additionally, when the accumulator 64 is in the holding state, the variation per unit time of the hydraulic pressure (leakage rate) when the working oil leaks from the accumulator 64 is determined based on the oil temperature. Then, the decreasing hydraulic pressure is time-integrated by the determined leakage rate. Thus, the accumulator internal pressure Pacc can be estimated. When the accumulator 64 is in the discharging state, the variation per unit time of the hydraulic pressure (discharge rate) when the working oil is discharged from the accumulator 64 is determined based on the oil temperature. Then, the decreasing hydraulic pressure is time-integrated by the determined discharge rate. Thus, the accumulator internal pressure Pacc can be estimated.

As described above, the transmission device 20 of the disclosure that is mounted on the vehicle (10) including the motor (12) configured to automatically stop and automatically start, that shifts and transmits power from the motor (12) to the axle via the engagement element (C1). The transmission device 20 includes the hydraulic control device (60) which has the pump (61) that discharges working oil into the hydraulic circuit (63) using power from the motor (12), and the accumulator (64) that accumulates hydraulic pressure in the hydraulic circuit (63). The hydraulic control device (60) controls the hydraulic pressure in the hydraulic circuit (63) and supplies the hydraulic pressure to the hydraulic servo of the engagement element (C1). The transmission device 20 also includes the start control device (80) that executes when the motor (12) starts up with a request for vehicle (10) travel: the fill control in which the hydraulic circuit (63) is controlled so that the hydraulic servo is filled with working oil; the standby control in which the hydraulic control device (60) is controlled so that the hydraulic pressure in the hydraulic servo is maintained at the standby pressure; and the engagement control in which the hydraulic control device (60) is controlled so that the increase of the hydraulic pressure in the hydraulic servo is started when the rotational speed of the motor (12) becomes equal to or more than the prescribed rotational speed, in this order, after the hydraulic pressure accumulated in the accumulator (64) is released into the hydraulic circuit (63), so that the engagement element is engaged.

Thus, it is possible to increase the standby pressure and promptly engage the engagement element, or decrease the standby pressure and suppress engagement shock, according to the state of the vehicle. As a result, it is possible to achieve a prompt engagement of the engagement element and suppress engagement shock when the stopped motor starts.

Additionally, the start control device (80) can change the standby pressure in the standby control based on the state of the vehicle (10). In this way, it is possible to increase the standby pressure, promptly engage the engagement element, and suppress racing of the motor, or decrease the standby pressure and suppress engagement shock, according to the state of the vehicle.

In this case, the transmission device (20) has the accumulator hydraulic pressure acquisition unit (64a) that acquires the hydraulic pressure accumulated in the accumulator (64). The start control device (80) can set the upper limit value of the standby pressure based on acquired the hydraulic pressure in the accumulator (64), and change the standby pressure based on the state of the vehicle (10) within a range that does not exceed the upper limit value.

In this case, the transmission device (20) also has the accelerator operation amount detection sensor (92) that detects the accelerator operation amount by the driver. The start control device (80) can change the standby pressure based on the detected accelerator operation amount within a range that does not exceed the upper limit value.

Additionally, the transmission device (20) has the accumulator hydraulic pressure acquisition unit (64a) that acquires the hydraulic pressure accumulated in the accumulator (64). The start control device (80) can discontinue the execution of the standby control, when the acquired hydraulic pressure in the accumulator (64) becomes equal to or less than the prescribed pressure, before the rotational speed of the motor (12) reaches the prescribed rotational speed during execution of the standby control.

The start control device (80) can discontinue the execution of the standby control, when the rotational speed of the motor (12) does not reach the prescribed rotational speed until a prescribed time passes since start-up of the motor (12) is initiated during execution of the standby control.

The automatic transmission 25 is described to be capable of forming the first to eighth forward speeds and the first and second reverse speeds. However, the the automatic transmission 25 may be an automatic transmission with any number of shift speeds.

Here, the correspondence between the main elements of the above embodiments and the main elements of the application described in the “SUMMARY” will be described. In the embodiment described above, the engine 12 corresponds to a “motor”, the oil pump 61 corresponds to a “pump”, the accumulator 64 corresponds to an “accumulator”, the hydraulic control device 60 corresponds to a “hydraulic control device”, and the transmission ECU 80 that executes the processing of steps S200 to S230 of the start-off control routine and the standby control routine corresponds to a “start control device”. The pressure sensor 64a corresponds to an “accumulator hydraulic pressure acquisition unit”. The accelerator pedal position sensor 92 corresponds to an “accelerator operation amount detection sensor”.

While modes for carrying out the invention of the disclosure have been described above by way of embodiments, the invention of the disclosure is not limited to the embodiments in any way, and it is a matter of course that the invention of the disclosure may be implemented in various modes without departing from the scope of the invention of the disclosure.

### INDUSTRIAL APPLICABILITY

The disclosure is applicable to the manufacturing industry of transmission devices.

1. A transmission device that is mounted on a vehicle including a motor configured to automatically stop and automatically start, that shifts and transmits power from the motor to an axle via an engagement element, comprising:
a hydraulic control device which has a pump that discharges working oil into a hydraulic circuit using power from the motor, and an accumulator that accumulates hydraulic pressure in the hydraulic circuit, and which controls the hydraulic pressure in the hydraulic circuit and supplies the hydraulic pressure to a hydraulic servo of the engagement element; and
a start control device that executes, when the motor that automatically stopped starts up with a request for vehicle travel: a fill control in which the hydraulic control device is controlled so that the hydraulic servo is being filled with working oil; a standby control in which the hydraulic control device is controlled so that hydraulic pressure in the hydraulic servo is maintained at a standby pressure; and an engagement control in which the hydraulic control device is controlled so that the increase of hydraulic pressure in the hydraulic servo is started when a rotational speed of the motor becomes equal to or more than a prescribed rotational speed, in this order, after hydraulic pressure accumulated in the accumulator is released into the hydraulic circuit, so that the engagement element is engaged.

2. The transmission device according to claim 1, wherein
the start control device changes the standby pressure in the standby control based on a state of the vehicle.

3. The transmission device according to claim 2, wherein
the transmission device has an accumulator hydraulic pressure acquisition unit that acquires a hydraulic pressure accumulated in the accumulator, and
the start control device sets an upper limit value of the standby pressure based on the acquired hydraulic pressure in the accumulator and changes the standby pressure based on the state of the vehicle within a range that does not exceed the upper limit value.

4. The transmission device according to claim 3, wherein
the transmission device has an accelerator operation amount detection sensor that detects an accelerator operation amount by a driver, and
the start control device changes the standby pressure based on the detected accelerator operation amount within a range that does not exceed the upper limit value.

5. The transmission device according to claim 1, wherein
the transmission device has an accumulator hydraulic pressure acquisition unit that acquires a hydraulic pressure accumulated in the accumulator, and
the start control device discontinues the execution of the standby control, when the hydraulic pressure in the accumulator acquired before a rotational speed of the motor reaches the prescribed rotational speed during execution of the standby control becomes equal to or less than a prescribed pressure.

6. The transmission device according to claim 1, wherein
the start control device discontinues the execution of the standby control, when a rotational speed of the motor does not reach the prescribed rotational speed until a prescribed time passes since the start-up of the motor is initiated during execution of the standby control.
